(19) United States
(12) Patent Application Publication
(10) Pub. No.: US 2016/0258599 A1
(43) Pub. Date: Sep. 8, 2016

(54) Portable Lamp Fitted with Electric Control of the Geometry of the Beam

(71) Applicant: Zedel S.A., Crolles (FR)

(72) Inventor: Fabien Genthon, Tencin (FR)

(21) Appl. No.: 15/155,439

(22) Filed: May 16, 2016

Related U.S. Application Data
(63) Continuation of application No. PCT/EP2015/053127, filed on Feb. 13, 2015.

(30) Foreign Application Priority Data
Feb. 14, 2014 (FR) 14/00407

(51) Int. Cl. F21V 14/00; F21V 23/04; F21V 23/00

(52) U.S. Cl. CPC F21V 14/003; F21V 23/003; F21V 23/0442; F21Y 2101/02

(57) ABSTRACT

The invention relates to a portable electric lamp with a light source generating at least one light beam; and a pane of glass arranged in front of the light source. The pane of glass has an electro-optical diffusion device controlled by an electrical signal in order to generate electrically adjustable diffusion. This diffusion generates a light beam with variable geometry from the single narrow beam. This results in headlamps with improved control of the geometry of its lightbeams.

### TECHNICAL FIELD

The present invention relates to portable electric lamps, and in particular to a headlamp having an improved control of the geometry of the light beam.

### BACKGROUND

The Applicant of the present application has contributed significantly to the development of new portable lamps, improving comfort and lighting of their users in all is kind of sports situations (caving, climbing, jogging, etc...) or professional (rescue, pruning, mine etc . . . )

In French patent application FR2893811 filed Nov. 21, 2005, the Applicant has proposed a portable electric lamp as shown in FIG. 1, including at least two light sources with distinct beams—respectively narrow/long and wide/short—respectively generated by a central light source 1d and an annular light source 1e. Combining their respective beams by means of a single control allows the generation of an effect of “zooming.” This effect of “zoom” remains fairly limited with a relative variation of the beam angle. Furthermore , this embodiment requires two separate sources of light, which can significantly increase the manufacturing costs and also the size of the light source. Finally, and this was not the least annoying inconvenience, in order to have a homogeneous light output , it is necessary that the light sources are perfectly matched, which can be difficult. And even more, when considering that, in general, LEDs have different aging profiles causing very quickly a loss of homogeneity in the production of the respective luminous fluxes of the two (or more) LED lamps, thus reducing the effectiveness of the “zooming” effect being searched.

### SUMMARY

The invention solves a number of problems. One solved problem is the opportunity to integrate the zoom effect in the “dynamic” or “reactive” lighting invented by the Applicant of the present application. Indeed, in application WO2009/133309, the Applicant has invented the so-called concept of “dynamic lighting” or “reactive lighting” which, briefly and as shown in FIG. 2, is based on a headlamp comprising at least one light emitting diode 11 (LED) and an optical sensor 14 located in its vicinity for sensing a signal representative of the light reflected by the surface of an object 16 being illuminated by the lamp. A control circuit 13 processes this signal so as to automatically control the power of the LED according to a predetermined threshold. In this manner, automatic control of the light beam emitted by the lamp is achieved is without further manual action so as to adjust the lighting to the environment, while also optimizing the power consumption and the life of the battery. If the principle of this “dynamic” lighting undeniably is a significant advance in the field of headlamps and more generally of the portable lighting, however, it remains necessary to combine this light with a powerful zoom effect, allowing constant effective and flexible adaptation of the illumination in accordance with the lighting conditions.

Moreover finally, in the international patent application WO2012/119756, the Applicant has introduced a headlamp with a variable geometry beam device controlled by an analysis of an image generated by an image sensor. For such a highly sophisticated lamp, it also appears desirable to have a “zoom” allowing the control of the geometry of the light beam that is particularly efficient and flexible to greatly benefit the possibilities offered by this new lamp technology .

It can thus be seen that there is still a wish for an effective and flexible mechanism for controlling the beam geometry and which allows easy and effective integration into the latest portable lamp technologies, and especially the so-called “dynamic” lighting lamp. In addition, it is desirable to provide an effective solution to problems of space, cost and finally the problem of aging of the light sources.

The present invention proposes to significantly improve this situation by achieving a new device for controlling the geometry of the beam which is perfectly suited to the new requirements introduced with the new facilities offered by modern headlamps.

It is an object of the present invention to carry out a portable lamp structure, such as a headlamp, allowing easier control of the geometry of the light beam.

It is another object of the present invention to provide a device for controlling the geometry of the beam generated by a portable lamp, reducing manufacturing costs but also the lamp clutter.

It is still another object of the present invention to provide a portable lamp device enabling fine control of the geometry of the beam and adapted to dynamic lighting.

The invention achieves these objects by means of a portable electric lamp, such as a headlamp, comprising:
a light source generating at least one light beam generates a narrow beam;
a panel arranged in front of said light source, said panel having an electric-optical diffusion device controlled by an electric signal for producing an electrically adjustable diffusion,

so as to generate a light beam of variable geometry from the single narrow beam.

The electro-optical device may be a liquid crystal diffuser controlled either by a current or by a control voltage.

In one embodiment, the panel consists of a Diffusion Polymer Liquid Cristal (DPLC) film through which passes said narrow beam, the DPLC film comprising biasing electrodes for receiving a control voltage for controlling the transparency of said film.

Preferably, the portable lamp includes:
a light source comprising at least one LED generating a narrow beam;
a source of power for powering the LEDs;
a control unit for generating a control potential for controlling the transparency of said DPLC film.

In a particular embodiment, the control voltage is generated from a manually controlled actuator.

Alternatively, the control voltage is generated from an information generated by a sensor sensing a fraction of the light being reflected on an object illuminated by the beam.

Alternatively, the control voltage is generated from an information generated by an accelerometer sensor, allowing the control of lamp lighting as the user is running or jogging.

In a particular embodiment, the control voltage is generated from an information generated by an image sensor.

More specifically, the portable lamp comprises communication means for receiving a control information which can be used for deriving the adjustable transparency control potential. This information can come from either another lamp—being interconnected and which may be configured in master mode—or from a data processing device such as a mobile phone, tablet etc .. which may also be used for controlling the features of the portable lamp.

In a specific embodiment, the portable lamp is particularly suitable for producing a headlamp.

### BRIEF DESCRIPTION OF THE DRAWINGS

Other features of one or more embodiments of the invention will appear from the following description of embodiments of the invention, with reference being made to the accompanying drawings.

FIG. 1 illustrates the principle of a conventional lamp fitted with an “electric zoom” facility.

FIG. 2 represents the general principle of a conventional lamp fitted with the so-called “dynamic lighting”.

FIG. 3 illustrates a first preferred embodiment of a portable lamp comprising is an electrically adjustable transparent glazing.

FIG. 4 illustrates a second embodiment combining an electro-optical diffuser with dynamic lighting lamp.

FIG. 5 illustrates a third embodiment of a portable lamp comprising an accelerometer used for generating the control potential of the electro-optical diffuser.

FIG. 6 shows a fourth embodiment of a portable lamp comprising an image sensor and an image processor for generating a control information for generating the control potential of the electric optical diffuser .

FIG. 7 shows a fifth embodiment of a portable lamp comprising communication means for receiving information for generating the control potential of the electro-optical diffuser.

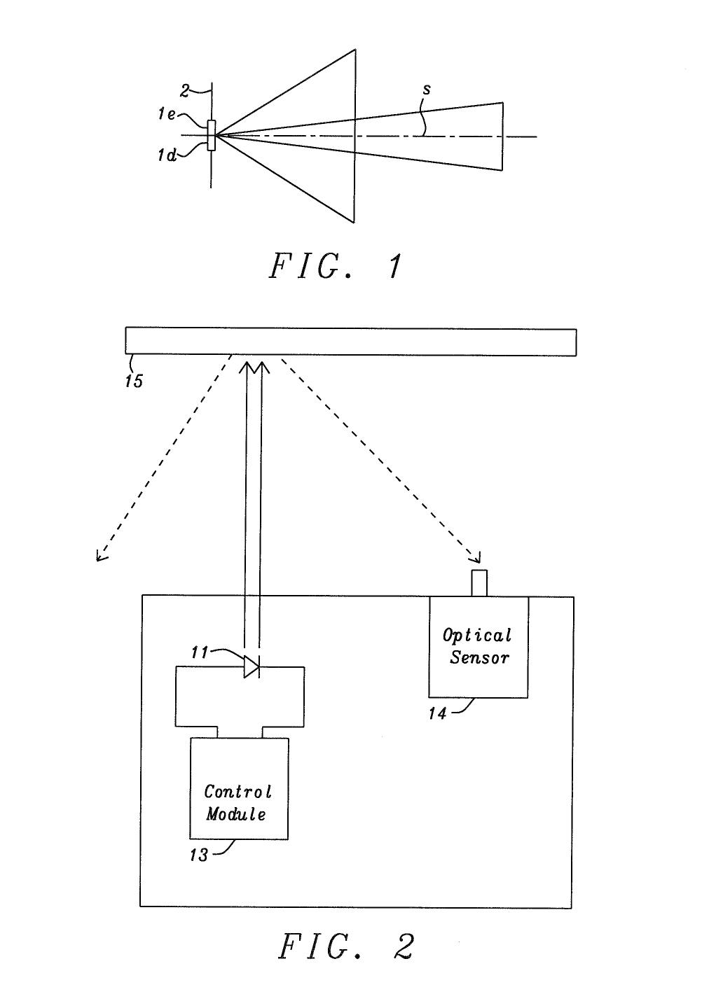

### DESCRIPTION

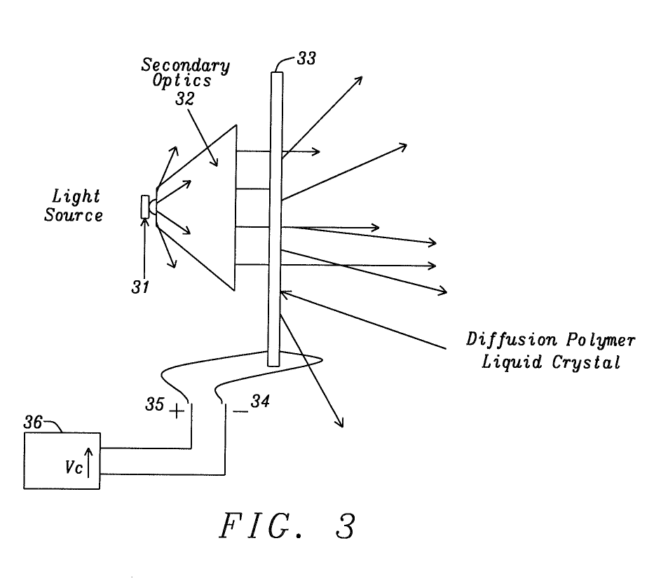

There will now be described, in relation to FIG. 3, a particular embodiment of a lamp, such as a headlamp generating a light beam, and provided with an improved device for controlling the geometry of the light beam.

The lamp includes a light source 31 which produces a light beam 31 generated for example by means of one or more LED(s). The light source 31 may be provided with a primary optics for providing first collimating so as to allow the formation of a rather narrow beam.

Optionally, a secondary optics 32 may be provided to improve, as necessary, the collimation of the source and thus increase, as appropriate, the narrow beam geometry.

The lamp furthermore has an electro-optical device 33 disposed in front of the light source, such as an electro-optical diffuser allowing electrical control transparency/opacity, so as to control the geometry of the light beam generated by the LED or (s).

Preferably the electro-optical device 33 is made of a panel of Diffusion Polymer

Liquid Cristal (DPLC) film (Liquid crystals dispersed in polymer or polymer dispersive liquid crystal) which, as known by a skilled man, consists of a particular implementation of crystals liquid heterogeneous dispersion in a polymer matrix.

This DPLC film may advantageously replace the glass conventionally disposed in front of the light source and protecting the latter, and which comprises two biasing terminals 34 and 35 receiving a control signal, for example a control voltage Vc generated by a control unit 36 .

Thus, one can achieve an advantageous combination of a specifically narrow light source and an electro-optical DPLC diffuser which can be electrically controlled so as to generate light beams various shapes of light beams, since the narrowest beam (when the film DPLC is completely transparent) to a maximum diffusion providing light scattering in all directions, as illustrated in FIG. 3.

With this particularly advantageous arrangement, it is thus possible to generate, by means of a single narrow beam light source, for example less than 10 degrees, a large variety of angles or beamwidths. The portable lamp can therefore ensure new features (floodlight—lantern—dawn simulator alarm).

And these new features will be permitted while significantly reducing the size of the lamp since, in the best case, only one single LED will be required to produce a wide variety of light beams.

Furthermore, the problem of matching the LEDs and their profiles aging is also solved since one single LED can be used for generating a plurality of beams which always present an homogenous color.

The invention can thus be used for effectively solving quite a number of problems arising in the development of an ‘electrically controlled zoom’.

One can further note an aesthetic advantage since, in the absence of any control voltage Vc and when the lamp is switched off, the latter is fully grained and has, therefore, quite a nice appearance.

In one particularly simple embodiment, the control voltage Vc is controlled via a switch or a manual actuator which can be operated by the lamp user, which may thus set—as desired—the angle of the generated beam.

Alternatively—and this shows the great flexibility of the device being described—it will automatically adjust the potential Vc from various information data.

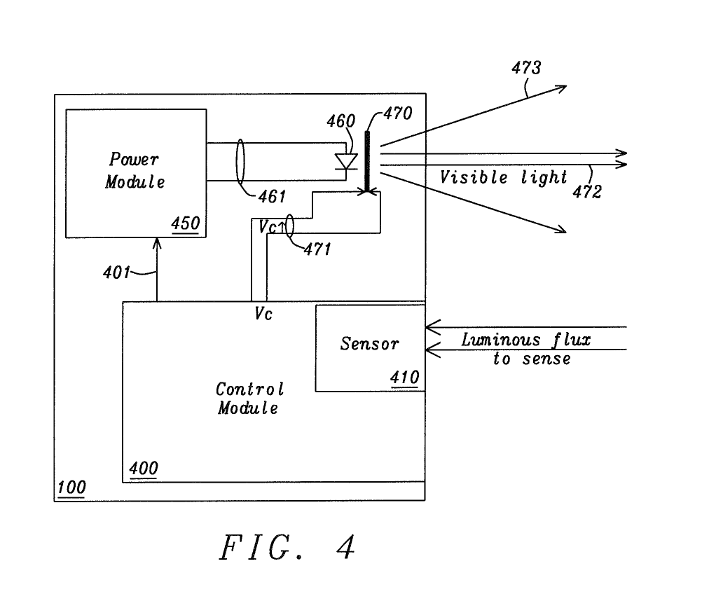

FIG. 4 illustrates a second embodiment of a lamp 100, assumed to be a headlamp, which advantageously combines the use of an electro-optical diffuser in a “dynamic” or “reactive” type lamp.

The lamp 100 includes a power module 450 associated with a control module 400 and a light source 460 having one or more LED (s) which has/have, when appropriate, its/their own focal system (not shown in the figure).

In the example in FIG. 4, one shows, for the sake of simplification, a single LED 460 which is powered by leads 461 being connected to power module 450, which clearly represents the most compact embodiment.

However, where the compactness is critical, one can consider, particularly for the purpose of increasing the brightness of the lamp, to use several diodes into a single focal optical system, or even multiply the number of optical systems so as to increase the possibilities of use of the lamp. In particular, one can consider theh use of more imposing LEDs, for instance of the multi-chip type (Creates XLM2) combined with the most impressive optics, enabling a more sophisticated embodiment.

In a specific embodiment, the powering of LED diode 460—via leads 461—is carried out under the control information or a control signal 401 generated by the control module 400.

Power module 450 specifically includes all components that are conventionally found in an LED illumination lamp for producing a light beam of high intensity, and in general based on Pulse Width Modulation PWM, well known to the skilled man and similar to that known and used in class audio circuits D. The PWM modulation is controlled by the control signal 401. Generally speaking, the term “signal” mentioned above refers to an electrical quantity—current or voltage—that can cause control of the power module 450, including the PWM modulation used to supply power to the LED 460. This is only one particular embodiment, with the understanding that it will be possible to substitute to “control signal 401” any “control information” such a logical information stored in a register and transmitted by any appropriate means to power module 450 in order to control the transmission power of the light beam. In one particular embodiment, we can even consider the two control modules 400 and power 450 are integrated within the same integrated circuit.

A skilled person can therefore easily understand that that when we refer to a “control signal 401” is indiscriminately encompasses embodiments using an electrical quantity control—current or voltage—and the embodiments in which the command is effected by means of a logic information transmitted within the power module 450. For this reason, one will hereinafter indiscriminately use the wordings “control signal” or “control information”.

In general, switches and switching components that constitute power module 450—which can be either bipolar transistors, FETs (Field Effect Transistor) or MOS (Metal Oxide Semiconductor) or MOSFET—are well known to a skilled man and the presentation will be deliberately reduced in this regard for brevity. Likewise, we invite the reader to refer to the general literature on various aspect of the PWM modulation.

As seen in FIG. 4, control module 400 particularly comprises a sensor 410 having its own focal optical module, which is used for sensing a portion of the light being reflected on the illuminated object or zone, so as to generate an useful information for carrying out the so-called “dynamic” or “reactive” lighting .

The information produced by sensor 410 is processed by control module 400 so as to derive a control voltage Vc by means of appropriate logic and analog circuits. This control voltage Vc is transmitted via appropriate leads 471 to a DPLC film 470 so as to control the diffusion of the light beam passing through the latter.

More specifically, the diffusion control is such that, in the absence of any control voltage Vc, the diffusion of the DPLC film 470 is maximum, thus producing the light rays in all directions (shown by the beam 473 in FIG. 4). On the contrary, when control module 400 generates a significant control voltage Vc—in the order of 75 volts today but with the aim of lowering in the value of 24 volts—the DPLC film will show a perfect or almost full transparency, so that only a narrow beam 472 will be generated by the portable lamp.

With such a device, one can therefore automatically control the coefficient of diffusion of the DPLC film via control voltage Vc, and such control is derived from the reflection of light on an illuminated object sensed by sensor 410.

One thus significantly improves the conventional “dynamic” or “reactive” lamp by integrating in the latter an electrically controllable DPLC film. More specifically, the io possibility of electrically controlling the electro-optical diffuser greatly simplifies the feedback loop allowing the control of the diffusion based on the light sensed by the sensor 410.

This makes lamp 100 of FIG. 4 particularly flexible for quite a large number of control loops which can be used.

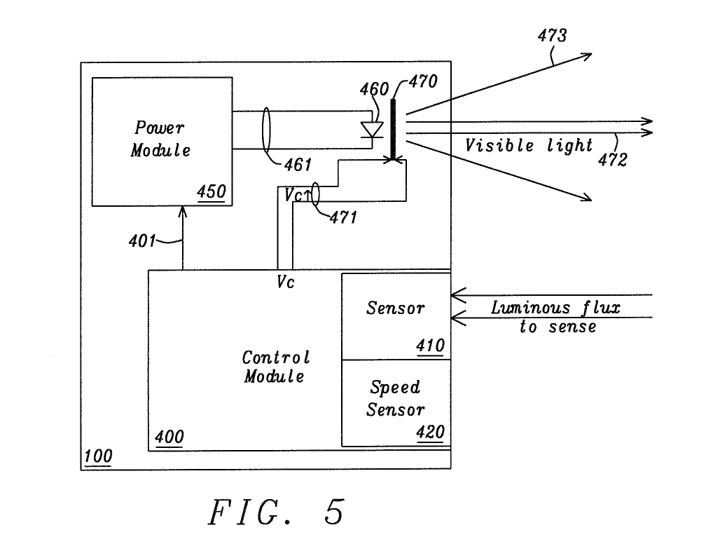

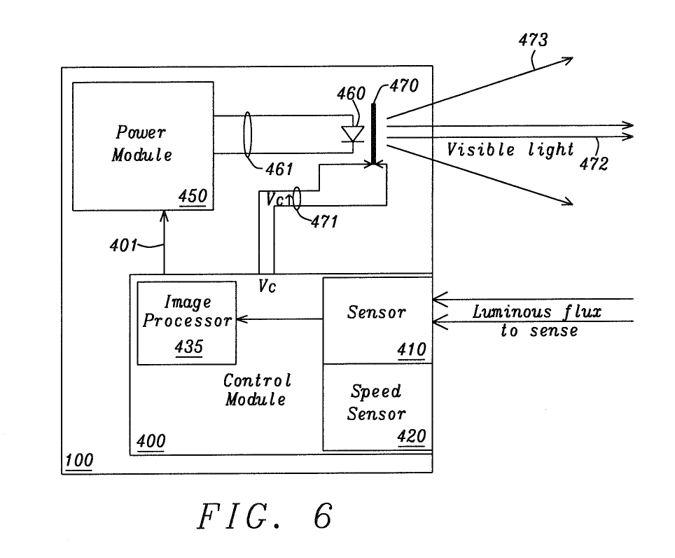

But this certainly does not exhaust the possibilities of the described embodiment, which can allow a wide variety of different controls, as this is illustrated in FIG. 5, wherein all components identical to those of FIG. 4 retain their references. This device of FIG. 5 further includes a speed sensor or accelerometer sensor 420 which can be added, or substituted to sensor 410. Such acceleromter sensor is particularly useful for detecting a situation where the lamp user makes significant moves, for instance if he is running, in which case, it can be useful to automatically control, through the control unit 400, the generation of a narrower and stronger beam.

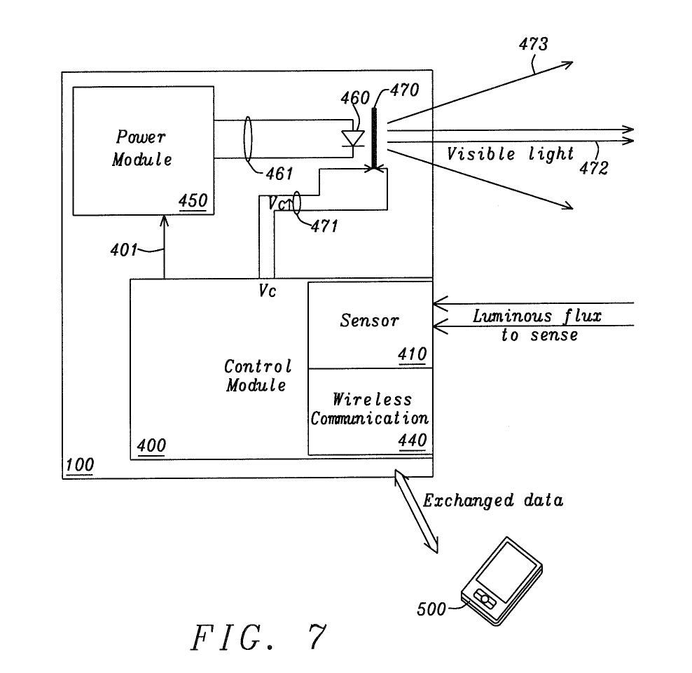

FIG. 6 shows another example of a more sophisticated embodiment in which the lamp includes an image processor 435 such as that described in patent application WO 2012/119756 dated Mar. 6, 2012, and allowing control of the geometry the beam from an image analysis performed by an image processor 435 shown in FIG. 6. Such analysis of the image sensed leads, thanks to an appropriate image processing, to the generation of an control voltage Vc which can be used for controlling the diffusion factor of the DPLC film 470. The reader is particularly invited to refer to the developments described in this patent application for carrying out such a particular portable lamp incorporating an image sensor.

FIG. 7 shows another embodiment wherein one adds, to the elements described in the embodiment of FIG. 4, and which—for the sake of brevity—shall keep their reference numerals, a wireless communication unit 440, and particularly transmission/reception circuits for receiving a control information from a device being external to the lamp, said information being used for generating the control voltage Vc for controlling the diffusion of the electro-optical diffusion device.

In a particular embodiment, the communication circuits may be Bluetooth or equivalent type and allow an exchange of information between two portable lamps so that a type of master/slave control between the two lamps.

It is thus possible, thanks to this arrangement to produce centralized control of the diffusion of the DPLC film.

Alternatively, the wireless communication circuits 440 are used for the exchange of data between the portable lamp and an external data processing device, such as a mobile phone or a touch pad 500 that will thus be able to take advantage of all the processing power available in these external devices, but also their communication capabilities. This allows control of the brightness of the beam but also its geometry thanks to the DPLC film 470.

This arrangement can be particularly advantageous as it will become possible to use the computing power which is available in these external devices, as well as the extended communication facilities which are thus permitted, so as to achieve a fine and effective tuning of the beam geometry.

With this communication capability, quite a number of new facilities and possibilities may be considered for the headlamp.

What is claimed is:

1. A portable electric lamp comprising:
a light source generating at least one light beam; and
a panel disposed in front of said light source, said panel comprising an electro-optical device driven by an electric signal for producing an electrically adjustable diffusion, so as to generate a light beam having a variable geometry from the single narrow beam.

2. The portable lamp according to claim 1 wherein said electro-optical device is a diffusion polymer liquid crystal controlled by a current.

3. The portable lamp according to claim 1 wherein said electro-optical device is a is diffusion polymer liquid crystal controlled by a voltage.

4. The portable lamp according to claim 3 wherein said panel comprises a PDLC film through which passes through said narrow beam, said DPLC film comprising biasing terminal for receiving a control voltage for controlling the transparency of said DPLC film.

5. The portable lamp according to claim 4 further comprising:
said light source comprising at least one LED generating a narrow beam
a power source for the power supply or the LEDs; and
a control unit for generating a control potential for controlling the transparency of said DPLC film.

6. The portable lamp according to claim 5 wherein said control voltage is generated by a manually operated actuator.

7. The portable lamp according to claim 5 wherein said control voltage is generated from information generated by a sensor sensing a fraction of the reflected light on an object illuminated by said portable lamp.

8. The portable lamp according to claim 5 wherein said control voltage is generated from information generated by an accelerometer type sensor

9. The portable lamp according to claim 5 wherein said control voltage is generated from information generated by an image sensor.

10. The portable lamp according to claim 5 wherein said lamp comprises communication means and said control voltage is generated from information received by said communication means.

11. The portable lamp according to claim 10 wherein said control voltage is generated from information received from another lamp being configured in master mode lamp and communicating with said portable lamp.

12. The portable lamp according to claim 10 wherein said control voltage is generated from information generated by a smartphone/tablet type device via a wireless communication channel.

13. The portable lamp according to claim 1 wherein said portable lamp comprises a head lamp having a single LED generating a narrow beam of less than 10 degrees, which can be transformed into a scattering light by means of a control signal.

14. A method of providing a portable electric lamp comprising the steps of:
generating at least one light beam with a light source; and
producing an electrically adjustable diffusion with a panel disposed in front of said light source, said panel comprising an electro-optical device driven by an electric signal, so as to generate a light beam having a variable geometry from the single narrow beam.

15. The method according to claim 14 wherein said electro-optical device is a diffusion polymer liquid crystal controlled by a current.

16. The method according to claim 14 wherein said electro-optical device is a diffusion polymer liquid crystal controlled by a voltage.

17. The method according to claim 16 wherein said panel comprises a PDLC film through which passes through said narrow beam, said DPLC film comprising biasing terminal for receiving a control voltage for controlling the transparency of said DPLC film.

18. The method according to claim 17 further comprising:
said light source comprising at least one LED generating a narrow beam
a power source for the power supply or the LEDs; and
a control unit for generating a control potential for controlling the transparency of said DPLC film.

19. The method according to claim 18 wherein said control voltage is generated by a manually operated actuator.

20. The method according to claim 18 wherein said control voltage is generated from information generated by a sensor sensing a fraction of the reflected light on an object illuminated by said portable lamp.

21. The method according to claim 18 wherein said control voltage is generated from information generated by an accelerometer type sensor

22. The method according to claim 18 wherein said control voltage is generated from information generated by an image sensor.

23. The method according to claim 18 wherein said lamp comprises communication means and said control voltage is generated from information received by said communication means.

24. The method according to claim 23 wherein said control voltage is generated from information received from another lamp being operated in master mode lamp and communicating with said portable lamp.

25. The method according to claim 23 wherein said control voltage is generated from information generated by a smartphone/tablet type device via a wireless communication channel.

26. The method according to claim 14 wherein said portable lamp comprises a head lamp having a single LED generating a narrow beam of less than 10 degrees, which can be transformed into a scattering light by means of a control signal.
